(19) United States
(12) Patent Application Publication
(10) Pub. No.: US 2011/0313636 A1
(43) Pub. Date: Dec. 22, 2011

(54) METHOD FOR OPERATING A DRIVETRAIN OF A MOTOR VEHICLE

(75) Inventor: Ulrich Franz Uhlirsch, Herrlingen (DE)

(73) Assignee: Dr. Ing. h.c. F. Porsche Aktiengesellschaft, Stuttgart (DE)

(21) Appl. No.: 13/160,694

(22) Filed: Jun. 15, 2011

(30) Foreign Application Priority Data
Jun. 17, 2010 (DE) 102010017406.8

(51) Int. Cl. F02D 41/00

(52) U.S. Cl. 701/102

(57) ABSTRACT

A method for operating a drivetrain of a motor vehicle, the drivetrain having a drive unit with an internal combustion engine and with at least one turbocharger, a driver demand torque being determined as a function of a present accelerator pedal actuation (PI), a drive unit torque (M_{NEW}) which is dependent on the driver demand torque (M_{DD}) provided by the drive unit via a load shock damping facility such that the drive unit torque (M_{NEW}) is built up as a function of the driver demand torque via load filter gradients of the load shock damping facility, and wherein in the case of a relatively high driver demand torque, to ensure a comfortable and dynamic build-up of the drive unit torque using the or each turbocharger, a nominal value (M_{NOM,2}) for an air-based torque is increased more quickly to a maximum value than a nominal value (M_{NOM,1}) for an ignition-based torque.

### CROSS-REFERENCE TO RELATED APPLICATION

This U.S. patent application claims priority to German Patent Application DE 10 2010 017 406.8, filed Jun. 17, 2010, which is incorporated by reference herein in its entirety.

### FIELD OF THE INVENTION

The invention relates to a method for operating a drivetrain of a motor vehicle.

### BACKGROUND OF THE INVENTION

A drivetrain of a motor vehicle comprises a drive unit and a transmission. The present invention relates to a method for operating a drivetrain whose drive unit is formed by an internal combustion engine and at least one turbocharger which interacts with the internal combustion engine.

It is already known from practice for a driver demand or a driver demand torque to be determined as a function of a present actuation of an accelerator pedal or throttle pedal by the driver, that is to say as a function of a present accelerator pedal actuation, wherein a drive unit torque which is dependent on the driver demand torque is provided by the drive unit. To avoid abrupt load changes in the drivetrain as a result of a fast change in the accelerator pedal actuation, it is known from practice to provide the drive unit torque as a function of the driver demand torque via a so-called load shock damping facility, wherein in the case of a load shock damping facility, the drive unit torque is built up by the drive unit as a function of the driver demand torque via so-called load filter gradients.

A load filter gradient is to be understood to mean a preferably ramp-shaped torque build-up which, for example in the event of a step-like change in the accelerator pedal actuation or a step-like change of a driver demand torque, is limited by the load shock damping facility to a torque build-up rate adapted to the driver demand, without inciting excessive vibrations or jerks in the drivetrain.

From practice, a load shock damping facility is already known which operates with three load filter gradients for building up the drive unit torque as a function of the driver demand torque, wherein a first load filter gradient is active in the overrun mode of the motor vehicle, a second load filter gradient is active for the transition from the overrun mode into the traction mode of the motor vehicle, and a third load filter gradient is active in the traction mode of the motor vehicle.

When such a load shock damping facility having three load filter gradients is used in a drivetrain whose internal combustion engine interacts with at least one turbocharger, in the event of a step-like accelerator pedal actuation or pedal input PI, the profiles shown in FIG. 1 for the drive unit torque M and for the longitudinal acceleration a are generated.

FIG. 1 also shows a driver demand torque M_{DD} determined from the step-like pedal input PI, a nominal value M_{NOM,1} for an ignition-based torque of the internal combustion engine and a nominal value M_{NOM,2} for an air-based torque of the internal combustion engine, wherein said nominal values M_{NOM,1} and M_{NOM,2} are predefined by the load shock damping facility with the three load filter gradients and have an identical profile. The ignition-based torque of the internal combustion engine is to be understood to mean a drive unit torque which can be provided as a function of the ignition angle thereof and which is based on or dependent on the so-called ignition angle efficiency. The air-based torque of the internal combustion engine is to be understood to mean a drive unit torque which can be provided as a function of a cylinder charge of the internal combustion engine, it being possible for the cylinder charge to be influenced by means of load control elements of the internal combustion engine such as for example a throttle flap and/or a valve drive. The cylinder-charge-based air-based torque of the internal combustion engine is also referred to as base torque or torque of a slow torque path of the internal combustion engine. The ignition-based torque which is dependent on the ignition angle efficiency is also referred to as torque of a fast torque path of the internal combustion engine.

According to FIG. 1, when using a load shock damping facility with three load filter gradients, two peaks or high points a1 and a2 are formed in the profile of the longitudinal acceleration a. The peak a1 of the longitudinal acceleration a is caused by the initially prompt load step change of the internal combustion engine, specifically up to the torque which the internal combustion engine can provide, in effect, as a naturally-aspirated engine. The peak a2 of the longitudinal acceleration a is caused by the delayed load torque behavior of the or each turbocharger. This is dependent on the profile over time of the charge pressure build-up. A time period Δt between said two peaks a1 and a2 is perceptible to the driver as so-called turbo lag.

This is perceived by the driver as being uncomfortable and non-sporty, and there is accordingly a demand for the longitudinal acceleration a to be built up in the drivetrain without turbo lag perceptible to the driver.

### SUMMARY OF THE INVENTION

An object of the present invention is to provide an improved method for operating a drivetrain of a motor vehicle, which is described hereinafter.

Said object is achieved by means of a method for operating a drivetrain of a motor vehicle, the drivetrain having a drive unit with an internal combustion engine and with at least one turbocharger, a driver demand torque being determined as a function of a present accelerator pedal actuation, and a drive unit torque which is dependent on the driver demand torque being provided by the drive unit via a load shock damping facility in such a way that the drive unit torque is built up as a function of the driver demand torque via load filter gradients of the load shock damping facility, characterized in that, in the case of a relatively high driver demand torque, to ensure a comfortable and dynamic build-up of the drive unit torque using the or each turbocharger, a nominal value for an air-based torque of the drive unit is increased more quickly to a maximum value than a nominal value for an ignition-based torque of the drive unit.

According to aspects of the invention, in the case of a relatively high driver demand torque, to ensure a comfortable and dynamic build-up of the drive unit torque using the or each turbocharger, a nominal value for an air-based torque of the drive unit is increased more quickly to a maximum value than a nominal value for an ignition-based torque of the drive unit.

According to aspects of the invention, in the case of a relatively high driver demand torque, the nominal value for the so-called air-based torque, which is dependent on the charge pressure or the cylinder charge, is increased preferably abruptly to a maximum value. A nominal value of the so-called ignition-based torque, which is dependent on the ignition angle efficiency of the internal combustion engine, is increased preferably gradually to the maximum value. In this way, methods for load shock damping known from the prior art are expanded by a further load filter gradient for high driver demand torques, wherein said load filter gradient is active in particular in an upper part-load range between an, in effect, naturally-aspirated operating mode of the drive unit and a turbocharged operating mode of the drive unit. By means of the invention, a longitudinal acceleration can be built up in the drivetrain without turbo lag perceptible to the driver. Furthermore, the so-called response time can be shortened.

According to a further aspect of the invention, the nominal value for the air-based torque is increased abruptly to the maximum value, in particular the driver demand torque, in one step, whereas the nominal value for the ignition-based torque is increased gradually to the maximum value, in particular the driver demand torque, in a plurality of steps or along a linear guide ramp or along a non-linear guide curve.

### BRIEF DESCRIPTION OF THE DRAWINGS

Preferred refinements of the invention will emerge from the subclaims and from the following description. Exemplary embodiments of the invention will be explained in more detail on the basis of the drawing, without the invention being restricted to said exemplary embodiments. In the drawing:

FIG. 1 shows a diagram illustrating the prior art; and

FIG. 2 shows a diagram illustrating the method according to aspects of the invention for operating a drivetrain.

### DETAILED DESCRIPTION OF THE PREFERRED EMBODIMENTS

The present invention relates to a method for operating a drivetrain of a motor vehicle, wherein the drivetrain has a drive unit and a transmission. The drive unit comprises an internal combustion engine which interacts with at least one turbocharger. The invention now relates to a method for operating such a drivetrain, by means of which method a drive unit torque can be built up by the drive unit in a comfortable and dynamic manner as a function of a present actuation of an accelerator pedal or throttle pedal, wherein for this purpose, a driver demand torque is determined as a function of a present accelerator pedal actuation, and wherein a drive unit torque which is dependent on the driver demand torque is provided or built up by the drive unit via a load shock damping facility. A load shock damping facility comprises a plurality of load filter gradients which take effect as a function of the driver demand torque and via which the drive unit builds up drive unit torque as a function of the driver demand torque. For example, from practice, load shock damping methods are known which provide different or separate load filter gradients for the overrun mode, the traction mode and a transition region between the overrun mode and the traction mode of a drivetrain, in order to build up the drive unit torque for these operating regions as a function of the driver demand torque determined from the present accelerator pedal actuation.

With the present invention, it is now proposed that, in a drive unit with a turbocharger, in the event of a relatively high driver demand torque, to ensure a comfortable and dynamic build-up of the drive unit torque using the or each turbocharger, a further, separate load filter gradient be used, specifically in such a way that a nominal value for an air-based torque of the drive unit is increased more quickly to a maximum value than a nominal value for an ignition-based torque of the drive unit.

A nominal value for the air-based torque of the drive unit or internal combustion engine is preferably increased abruptly to a maximum value, whereas a nominal value for an ignition-based torque of the drive unit or internal combustion engine is increased gradually to a maximum value.

The ignition-based torque is to be understood to mean a drive unit torque which can be provided as a function of the ignition angle, and which is based on the so-called ignition angle efficiency. The air-based torque is to be understood to mean a drive unit torque which can be provided as a function of a cylinder charge, wherein the cylinder charge can be influenced by means of load control elements of the internal combustion engine. The cylinder-charge-based air-based torque of the internal combustion engine is also referred to as base torque or torque of a slow torque path of the internal combustion engine. The ignition-based torque which is dependent on the ignition angle efficiency is also referred to as torque of a fast torque path of the internal combustion engine.

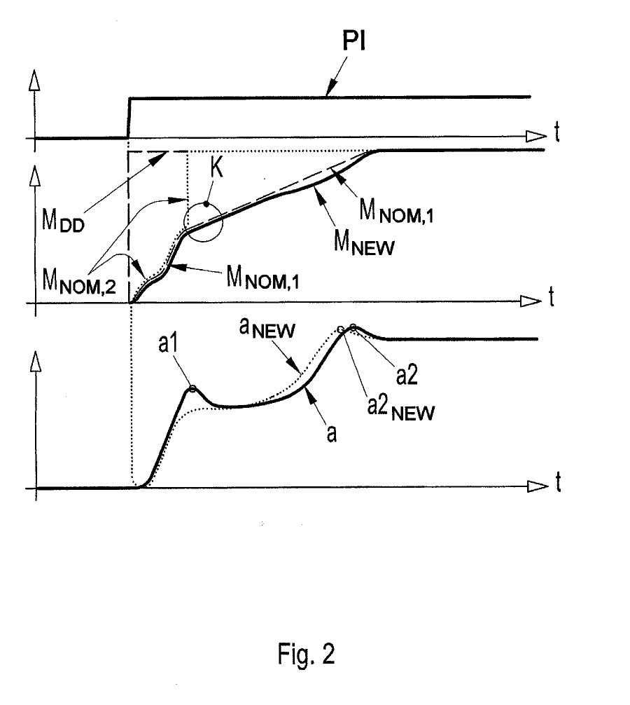

FIG. 2 thus shows, for a relatively high driver demand torque M_{DD}, firstly the nominal value M_{NOM,1} for the ignition-based torque of the drive unit and secondly the nominal value M_{NOM,2} for the charge-based torque of the drive unit, wherein, as already mentioned, the nominal value M_{NOM,2} for the air-based torque is increased to the maximum value abruptly and the nominal value M_{NOM,1} for the ignition-based torque is increased to the maximum value gradually.

Here, the profile shown in FIG. 2 for the drive unit torque M_{NEW} provided by the drive unit and the profile shown in FIG. 2 for the longitudinal acceleration a_{NEW} are formed. FIG. 2 also shows the longitudinal acceleration profile a according to the prior art, wherein it can be seen from a comparison of the longitudinal acceleration profile a according to the prior art and the longitudinal acceleration profile a_{NEW} provided according to aspects of the invention that, firstly, the first peak a1 in the longitudinal acceleration profile is eliminated when using the invention, and secondly, the second peak a2 in the longitudinal acceleration profile is pulled forward to a2_{NEW}, such that firstly turbo lag is no longer perceptible to the driver, and secondly, the response time until the maximum longitudinal acceleration is provided can be shortened.

As already stated, the nominal value for the air-based torque is increased preferably abruptly to the maximum value and the nominal value for the ignition-based torque is increased gradually to the maximum value, wherein said two maximum values are of equal magnitude, that is to say each correspond to the driver demand torque determined as a function of the accelerator pedal actuation.

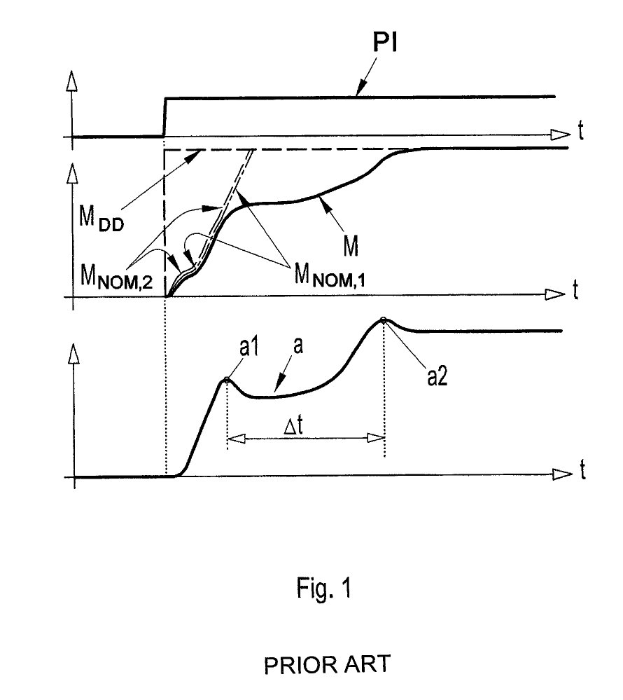

The nominal value M_{NOM,2} for the air-based torque is, according to FIG. 2, increased abruptly to the maximum value in one step. The nominal value for the air-based torque may also be increased along a guide curve, but faster than is shown in FIG. 1 for the prior art and faster than the nominal value for the ignition-based torque. According to FIG. 2, the nominal value M_{NOM,1} for the ignition-based torque is increased to the maximum value continuously along a linear guide ramp. In contrast to this, it is also possible for the nominal value M_{NOM,1} for the ignition-based torque to be increased gradually along a continuous, non-linear guide curve or gradually in a plurality of steps, discontinuously or quasi-continuously.

The present invention proposes a modified load shock damping facility for turbocharged internal combustion engines, which modified load shock damping facility in particular provides a separate load filter gradient for the transition region from the, in effect, naturally-aspirated operating mode of the internal combustion engine to the turbocharged operating mode of the internal combustion engine. In this way, perceptible turbo lag can be eliminated and the response time in the build-up of the longitudinal acceleration can be shortened. This increases both the driving comfort and also the dynamics or sportiness during the operation of the drivetrain.

If the invention is used in an internal combustion engine with a variable valve drive in which for example a valve lift switchover can be realized, the invention offers further advantages. A time is then preferably selected for a valve lift switchover such that the latter takes place in a region marked in FIG. 1 by the circle K. A valve lift switchover can often lead to step changes in a fresh gas charge of the cylinders. In order that said step changes do not have an effect on the drive unit torque M_{NEW} provided by the drive unit and consequently do not cause a jerk in the drivetrain, the profile of the nominal value M_{NOM,1} for the ignition-based torque is configured such that the step change in the cylinder charge is smoothed out.

1.-9. (canceled)

10. A method for operating a drivetrain of a motor vehicle having a drive unit with an internal combustion engine and with at least one turbocharger, said method comprising the steps of:
determining a driver demand torque as a function of a present accelerator pedal actuation, and
providing a drive unit torque, which is dependent on the driver demand torque, by the drive unit via a load shock damping facility in such a way that the drive unit torque is built up as a function of the driver demand torque via load filter gradients of the load shock damping facility,
wherein, in a case of a relatively high driver demand torque, the method further comprises the step of increasing a nominal value for an air-based torque of the drive unit more quickly to a maximum value than a nominal value for an ignition-based torque of the drive unit is increased to ensure a comfortable and dynamic build-up of the drive unit torque using the at least one turbocharger.

11. The method as claimed in claim 10, wherein, in the case of the relatively high driver demand torque, the method further comprises the steps of increasing the nominal value for the air-based torque abruptly to a maximum value and increasing the nominal value for the ignition-based torque gradually to a maximum value to ensure a comfortable and dynamic build-up of the drive unit torque using the at least one turbocharger.

12. The method as claimed in claim 11, wherein the maximum value of the nominal value for the air-based torque and the maximum value of the nominal value for the ignition-based torque are of equal magnitude.

13. The method as claimed in claim 11, wherein the maximum value of the nominal value for the air-based torque and the maximum value of the nominal value for the ignition-based torque are, in each case, of equal magnitude to the driver demand torque.

14. The method as claimed in claim 10, wherein the nominal value for the air-based torque is increased abruptly to the maximum value in one step.

15. The method as claimed in claim 10, wherein the nominal value for the ignition-based torque is increased gradually to the maximum value in a plurality of steps.

16. The method as claimed in claim 10, wherein the nominal value for the ignition-based torque is increased gradually to the maximum value along a continuous, linear guide ramp.

17. The method as claimed in claim 10, wherein the nominal value for the ignition-based torque is increased gradually to the maximum value along a continuous, non-linear guide curve.

18. The method as claimed in claim 10, wherein, in the event of a valve lift switchover, a profile of the nominal value for the ignition-based torque is configured such that a step change, caused by the valve lift switchover, in a charge of a cylinder of the engine does not cause a jerk in the drivetrain.
